(19) United States
(12) Patent Application Publication
(10) Pub. No.: US 2016/0309867 A1
(43) Pub. Date: Oct. 27, 2016

(54) SYSTEM AND METHOD FOR A COLLAPSIBLE DOLLY INCORPORATING A PROTECTIVE CASE

(71) Applicant: Gary Oberg, Denver, CO (US)

(72) Inventor: Gary Oberg, Denver, CO (US)

(21) Appl. No.: 15/091,751

(22) Filed: Apr. 6, 2016

Related U.S. Application Data
(60) Provisional application No. 62/150,772, filed on Apr. 21, 2015.

(51) Int. Cl. A45C 15/00; B62B 1/12; A45C 13/26; A45C 5/03; A45C 5/14

(52) U.S. Cl. CPC A45C 15/00; A45C 5/03; A45C 5/14; A45C 13/262; B62B 1/12

(57) ABSTRACT

Provided is a system and method for a collapsible dolly incorporating an existing protective case. The case has a lid with at least one generally flat section defining a first plane disposed above a coupling section for coupling the lid to a base section, the coupling section defining a second plane generally parallel to the first plane, the flat section and the coupling section interconnected by first and second parallel side walls, a top side wall and a bottom sidewall, the base section further providing a wheel assembly and opposite thereto a handle assembly. The collapsible dolly includes a reinforcing bracket structured and arranged to be disposed about and attached to at least a portion of the bottom sidewall, the reinforcing bracket providing first and second parallel ends each providing a first pivot point. There is also a folding ledge having a central platform section and a first side section and a second side section, each side section providing a second pivot point structured and arranged to align with and be coupled to first pivot points. The folding ledge has a first stowed position wherein the central platform section is generally parallel to the first plane and adjacent to the flat section of the lid, and a second deployed position when rotated about the first and second pivot points wherein the central platform section is generally perpendicular to the flat section of the lid. An associated method of use and kit for providing a collapsible dolly are also provided.

### CROSS REFERENCE TO RELATED APPLICATIONS

This application claims the benefit under 35 U.S.C. §119(e) of US Provisional Application No. 62/150,772 filed Apr. 21, 2015 and entitled SYSTEM AND METHOD FOR A COLLAPSIBLE DOLLY INCORPORATING A PROTECTIVE CASE, the disclosure of which is incorporated herein by reference.

### FIELD OF THE INVENTION

The present invention relates generally to a collapsible dolly for use with items such as luggage, the collapsible dolly incorporating a protective case as part of the collapsible dolly system.

### BACKGROUND

While traveling through airports many travelers find they are juggling, dropping, and wrestling with many bags. This may be especially true for professionals who are traveling frequently and striving to carry or at least port as much of their equipment as possible by themselves.

Engineers, lawyers, investigators, military personal, and many others frequently use highly durable cases that are designed and constructed to protect their contents, which are typically intended to be delicate and/or expensive equipment such as cameras, computers, scientific equipment or the like. Suitable for field use where these cases will protect their contents from the elements, they are also often desirable for travel as they often have internal cushioning, padding or other material to cradle and protect items from jar and shock.

Often the exterior of these cases is made from very durable materials such as polycarbonate. Further, many of these types of protective cases have a built in set of wheels and a towing handle, permitting the case to be wheeled along with the traveler rather than carried. One manufacturer of such cases is Pelican Products, LLC headquartered in Torrance Calif. and well known for their Pelican Cases.

As is typical with most travelers, those traveling with durable cases often have a collection of luggage pieces, some of which were checked, and some of which they kept as carry on luggage. When all of these pieces are brought together at baggage claim, the collection can be difficult to manage by hand. And there is typically a variety in the types of luggage—in addition to the durable case, there is often one or more soft sided bag which may hold clothing In the case of an Engineer or Technician reporting to a testing site, there may be protective clothing, respirators, etc . . . for a site inspection. Moreover, the professional engineer or technical traveler typically has a plurality of bags of different shapes and sizes.

Smaller bags may be balanced on larger bags, straps of one bag passed over handles of another, etc. In some situations, protective cases and their protected contents may weigh 40 to 70 pounds, further complicating the stacking, balancing, and transporting issues. Some frequent travelers seem to have perfected a near art to balancing luggage while moving from one place to another. Still, there is very often a real risk of one or more items being dropped.

In some situations it may be possible to rent a cart if one can be found. However, rental carts are generally intended for proximate use to the terminal—and taking them away by subway, train, car, or even walking is discouraged.

Of course, the traveler may opt to purchase his or her own portable dolly that he or she then must also travel with. U.S. Pat. No. 2,729,460 to Forman presents a rather typical type of collapsible luggage dolly. More specifically, Foreman teaches a collapsible luggage dolly having a substantially plane frame 10 having a pair of tubular longitudinal members 11 and 12, transverse members 13 and 14, wheels 43 and handle 18. This frame 10 may be compacted for transport and then expanded when desired for use. When used, luggage is disposed against the frame 10, the wheels 43 below and the handle 18 grasped.

U.S. Pat. No. 6,012,729 to Lin presents a Luggage System and Folding Dolly wherein latch units 40 secure the luggage piece 12 to the dolly 14. Moreover the dolly 14 is rather typical, having a base 24 connected to wheels 26, a handle 28 and handle frame 30 extending from the base 24 and a platform 60. As with Forman, Lin teaches that luggage 12 is disposed against the dolly 14 when in it's expanded ready for use form. Beyond Foreman, Lin teaches a latching system to secure the luggage piece 12 to the handle frame 30. This of course requires the luggage to be modified to have mating elements for the latching system—elements that may well catch on other objects as the latch elements protrude from the luggage at all times.

Another option is presented by U.S. Pat. No. 3,717,228 by Blair for an Attaché case that is convertible to a luggage dolly. More specifically, the Blair attaché case is composed of four basic frame elements 10, 12, 41, 16 interconnected by hinges in an accordion configuration, so that for transport the dolly system appears as an attaché case, but when expanded for use it becomes a dolly having a back frame and load platform 50 with a set of wheels 46 adjacent to the load platform and a handle 54 at the top of the back frame. Luggage is then disposed against the frame. As the attaché case itself is the folded state of the dolly, the attaché case cannot be said to provide any real internal storage for when expanded to perform as a dolly all internal structures are exposed.

Moreover, in each of these examples, and common to portable dollies in general, the portable or collapsible dolly is a distinct element. For transport it must be compacted and transported as a distinct piece of luggage or strapped to a piece of luggage. When desired for use it must be transformed from the compact state to the useful dolly state, at which time additional elements of luggage may then be disposed against it. With the ever increasing tendency of airlines and other transportation companies to charge for each piece of luggage, or extra pieces beyond a set “free” number granted as an element of ticket price or frequent traveler status, having an additional luggage element is not always desirable.

Hence there is a need for a method and system that is capable of overcoming one or more of the above identified challenges with portable dolly systems.

### SUMMARY OF THE INVENTION

Our invention solves the problems of the prior art by providing novel systems and methods for a collapsible dolly incorporating a protective case.

For one embodiment, provided is a collapsible dolly incorporating a protective case, including: a protective case having at least two halves defining a protected space therein, a first part providing wheels at a lower end and a handle at an upper end, and a second part providing a top, the second part further providing a coupling section for binding to the first part and a protruding section extending above and generally parallel to the coupling section, the protective case having a general wheel end and opposite thereto a general grasping end, the protruding section of the second part having a first end proximate to the wheel end and a second end proximate to the grasping end; a reinforcing bracket disposed about the first end of the protruding section; a folding ledge structured and arranged to rotatably couple to the second part adjacent to the first end of the protruding section and proximate to the wheel end, and rotate between a first position and a second position, the folding ledge in generally parallel contact with the protruding section when in the first position and extending generally perpendicularly to the protruding section and binding against the reinforcing section when in the second position.

In yet another embodiment, provided is a collapsible dolly incorporating an existing protective case having a lid having at least one generally flat section defining a first plane disposed above a coupling section for coupling the lid to a base section, the coupling section defining a second plane generally parallel to the first plane, the flat section and the coupling section interconnected by first and second parallel side walls, a top side wall and a bottom sidewall, the base section further providing a wheel assembly and opposite thereto a handle assembly, the collapsible dolly including: a reinforcing bracket structured and arranged to be disposed about and attached to at least a portion of the bottom sidewall, the reinforcing bracket providing first and second parallel ends with each providing a first pivot point; and a folding ledge having a central platform section and a first side section and a second side section, each side section providing a second pivot point structured and arranged to align with and be coupled to first pivot points, the folding ledge having a first stowed position wherein the central platform section is generally parallel to the first plane and adjacent to the flat section of the lid, the folding ledge having a second deployed position when rotated about the first and second pivot points wherein the central platform section is generally perpendicular to the flat section of the lid.

Yet in another embodiment, provided is a kit for providing a collapsible dolly incorporating an existing protective case having a lid having at least one generally flat section defining a first plane disposed above a coupling section for coupling the lid to a base section, the coupling section defining a second plane generally parallel to the first plane, the flat section and the coupling section interconnected by first and second parallel side walls, a top side wall and a bottom sidewall, the base section further providing a wheel assembly and opposite thereto a handle assembl, including: a reinforcing bracket structured and arranged to be disposed about and attached to at least a portion of the bottom sidewall, the reinforcing bracket providing first and second parallel ends; a folding ledge having a central platform section and a first side section and a second side section, each side section providing an area for pivot attachment to the respectively aligned first and second parallel ends; at least one pivot attacher for hinging the folding ledge to the reinforcing bracket; wherein when the reinforcing bracket and folding ledge are attached to an existing case, the folding ledge has a first stowed position wherein the central platform section is generally parallel to the first plane and adjacent to the flat section of the lid, the folding ledge having a second deployed position when rotated about the at least one pivot attacher wherein the central platform section is generally perpendicular to the flat section of the lid.

And yet further, in another embodiment provided is a method for providing a collapsible dolly, including: obtaining a protective case having a lid having at least one generally flat section defining a first plane disposed above a coupling section for coupling the lid to a base section, the coupling section defining a second plane generally parallel to the first plane, the flat section and the coupling section interconnected by first and second parallel side walls, a top side wall and a bottom sidewall, the base section further providing a wheel assembly and opposite thereto a handle assembly; obtaining a reinforcing bracket structured and arranged to be disposed about and attached to at least a portion of the bottom sidewall, the reinforcing bracket providing first and second parallel ends; disposing the reinforcing bracket about at least a portion of the bottom sidewall of the top, the first and second parallel ends being adjacent to respective first and second parallel sidewalls of the top; obtaining a folding ledge having a central platform section and a first side section and a second side section, each side section providing an area for pivot attachment to the respectively aligned first and second parallel ends of the reinforcing bracket; disposing the folding ledge about the reinforcing bracket to align the areas for pivot attachment of the first and second side sections to the respectively aligned first and second parallel ends of the reinforcing bracket; drilling a hole through each area for pivot attachment of the first and second side sections and the respectively aligned first and second parallel ends of the reinforcing bracket; and disposing a pivot attacher in each drilled hole to hinge the folding ledge to the reinforcing bracket; wherein with the reinforcing bracket and folding ledge attached to the protective case, the folding ledge has a first stowed position wherein the central platform section is generally parallel to the first plane and adjacent to the flat section of the lid, the folding ledge having a second deployed position when rotated about the at least one pivot attacher wherein the central platform section is generally perpendicular to the flat section of the lid.

### BRIEF DESCRIPTION OF THE DRAWINGS

At least one system and method for providing a collapsible dolly incorporating a protective case will be described, by way of example in the detailed description below with particular reference to the accompanying drawings, and

FIGS. 1A and 1B are perspective views of a collapsible dolly comprising a protective case, a reinforcing bracket and a folding ledge in accordance with at least one embodiment of the present invention;

FIGS. 2A, 2B, and 2C are perspective top, bottom and side views of a reinforcing bracket for the collapsible dolly in accordance with at least one embodiment of the present invention;

FIGS. 3A and 3B are perspective top and bottom views of the folding ledge for the collapsible dolly in accordance with at least one embodiment of the present invention;

FIG. 4 is a partial perspective view of the bottom of the protective case showing where the reinforcing bracket is disposed in accordance with at least one embodiment of the present invention;

FIGS. 5A and 5B are side views of a collapsible dolly comprising a protective case, a reinforcing bracket and a folding ledge in accordance with at least one embodiment of the present invention;

FIGS. 6A and 6B are front views of a collapsible dolly comprising a protective case, a reinforcing bracket and a folding ledge in accordance with at least one embodiment of the present invention;

FIG. 7 is a perspective view of a collapsible dolly in use to port an object in accordance with at least one embodiment of the present invention;

FIG. 8 is a kit for a collapsible dolly comprising a protective case, a reinforcing bracket and a folding ledge in accordance with at least one embodiment of the present invention; and

FIG. 9 is a flow diagram of a method for providing a collapsible dolly comprising a protective case, a reinforcing bracket and a folding ledge in accordance with at least one embodiment of the present invention.

### DETAILED DESCRIPTION

Before proceeding with the detailed description, it is to be appreciated that the present teaching is by way of example only, not by limitation. The concepts herein are not limited to use or application with a specific system or method for providing a collapsible dolly incorporating a protective case. Thus although the instrumentalities described herein are for the convenience of explanation shown and described with respect to exemplary embodiments, it will be understood and appreciated that the principles herein may be applied equally in other types of systems and methods for providing a collapsible dolly incorporating a protective case.

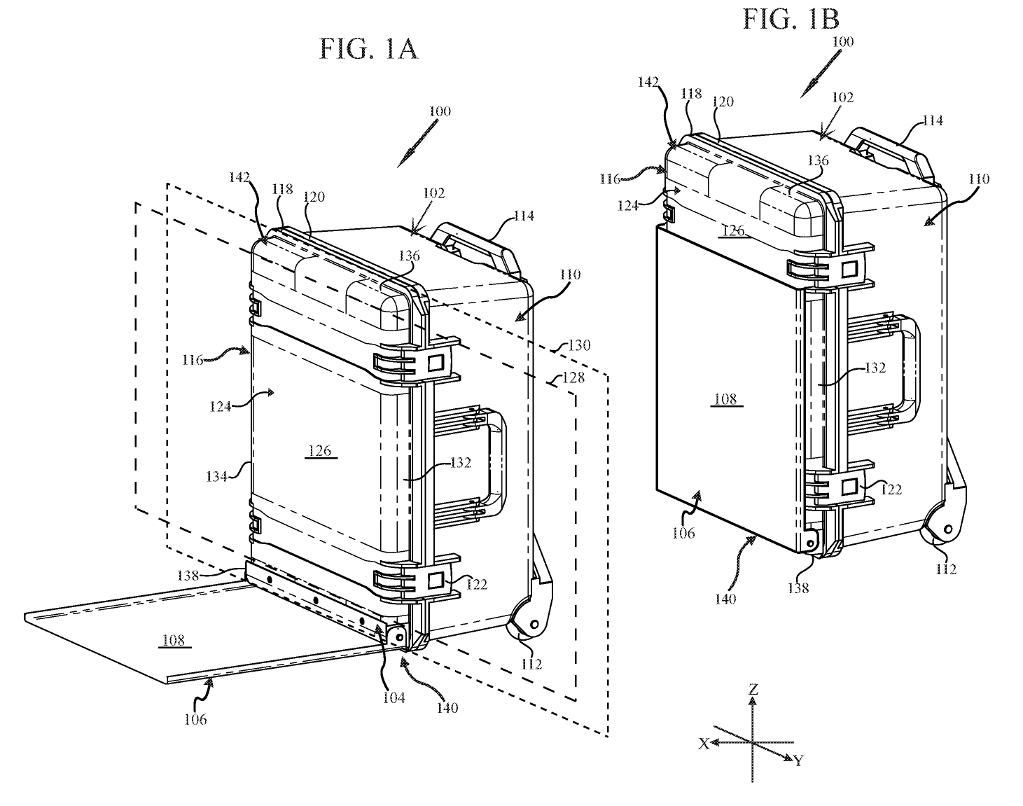

Turning now to FIGS. 1A and 1B, shown is a collapsible dolly 100 incorporating a protective case 102, a reinforcing bracket 104, and a folding ledge 106 having a central platform section 108, each of which is more fully discussed below. To facilitate the description of the systems and methods for collapsible dolly 100, the orientation of the collapsible dolly 100 as presented in the figures may be referenced to a coordinate system with three axes orthogonal to one another as shown in FIG. 1. The axes intersect mutually at the origin of the coordinate system, which in general is chosen to be the center of the collapsible dolly 100, however the axes shown in all figures are offset from their actual locations for clarity and ease of illustration.

As may be appreciated with respect to both FIGS. 1A and 1B, the folding ledge 106 of the collapsible dolly 100 has generally two positions, a first position shown in FIG. 1B where it is stowed, and a second position shown in FIG. 1A where it is deployed as a platform upon which items may be placed.

Collapsible dolly 100 may also be considered and understood as a porter shelf. In stark contrast to prior art systems for portable dolly systems, the present invention advantageously achieves a portable dolly system without requiring the traveling party to obtain and travel with an additional component, i.e. the dolly. More specifically, the present invention advantageously achieves and provides a collapsible dolly 100 as a component of a protective case.

As used herein, protective case 102 is understood and appreciated to be a durable case, such as but not limited to the line of protective cases manufactured and provided by Pelican Products, LLC headquartered in Torrance Calif.; SKB Corporation of Orange Calif.; Plasticase Inc. of Terrebonne, Quebec the manufacturer of Nanuk cases; C.R. Kennedy & Company, Pty Ltd. Of Melbourne, Australia the manufacturer of HPRC cases; Hive Lighting of Los Angeles, Calif.; Elephant Cases of Florida; Boulder Case Company of Englewood, Colo.; or other pre-provided protective case 102. Moreover, although for at least one embodiment collapsible dolly 100 may be assembled from components specifically manufactured to provide collapsible dolly 100, for alternative embodiments, collapsible dolly 100 may be achieved by the integration of an off the shelf, commercially available protective case 102 with an aftermarket reinforcing bracket 104, and a folding ledge 106.

More specifically, as shown in FIG. 1A there is a protective case 102. This protective case 102 has at least two haves defining a space therein. This internal space is typically used by a traveler to store and protect one or more items during transport. As shown, for at least one embodiment the protective case has a first part 110, i.e. the base section, that provides wheels 112 at a lower end and a handle 114 at the upper end. In FIG. 1, the handle 114 is shown stowed in the down/compact position. Typically the handle 114 may be pulled up so as to be more comfortable during use while wheeling the protective case 102 along behind the walking traveler.

Complementing the first part 110 of the protective case 102 is a second part 116, i.e. the lid. The second part 116 has a coupling section 118 for binding to the first part 110. As shown in the accompanying drawings, the coupling section 118 is generally a flat circumferential section of material. A corresponding coupling section 120 is provided by the first part 110 as well. Latches 122 are shown in FIG. 1, which temporarily bind the first part 110 and the second part 116 together as a latched protective case 102.

For at least one embodiment, the second part 116 is hinged to the first part 110. However, for at least one alternative embodiment, latches 122 may be used to secure the first part 110 and the second part 116 such that when unlatched the second part 116 may be entirely removed from the first part 110.

With respect to the accompanying drawings, and as shown in FIG. 1A, the second part 116, i.e. lid, has a protruding section 124 that extends outward from the coupling section 118. Moreover, this protruding section 124 has a general flat section 126 defining a first plane 128 that is disposed above the coupling section 118 when the second part 116, i.e., the lid, is disposed upon the first part 110, i.e., the base. The coupling section 118 generally defines a second plane 130 that is generally parallel to and offset from the first plane 128.

As is apparent in FIG. 1A the second part 116 is often formed from a continuous piece of material, such as plastic or polycarbonate. In other words it is understood and appreciated that the top flat section 126 of the protruding section 124 is generally continuously joined to the coupling section 118 by first sidewall 132 and parallel thereto second sidewall 134, as well as a top sidewall 136 and a bottom sidewall 138.

As will be further appreciated in FIG. 1, the sidewalls 130, 132 are generally parallel with the sides of the overall protective case 102 and the top sidewall 136 and bottom sidewall 138 are likewise parallel to each other and generally parallel with the top and bottom sides of the protective case 102. In varying embodiments the protective case may have additional elements providing additional structural integrity to the protective case 102 such that the first sidewall 132 and the second sidewall 134 may not necessarily be continuously smooth between the top flat section of the protruding section 124 and the coupling section 118.

For the exemplary protective case 102 as shown, the top sidewall 136 and bottom sidewall 138 of the protruding section of the second part 116 (e.g., the lid) are substantially symmetrical. For purposes of this discussion, the end of the second part 116 proximate to the wheels 112 of the first part 110 is understood to be the first end 140 and the end of the second part 116 proximate to the handle 114 of the first part 110 is understood to be the second end 142.

As shown in FIG. 1A, as the material providing the second part 116, i.e. lid transitions from the coupling section 118 to the top flat section 126 of the protruding section 124, it rises vertically away from the coupling section 118 as a generally straight wall and then curves to provided a rounded edge as it then provides the top flat section 126. This structure is quite advantageous for the present invention for it provides an attachment point for a reinforcing bracket 104, and a rotatiably coupled load platform, shown as a folding ledge 106 having a central platform section 108, which cooperatively combine with the protective case 102 to achieve the collapsible dolly 100.

Moreover, in FIG. 1A the folding ledge 106 is deployed such that it extends generally perpendicularly to the protruding section 124, such that the central platform section 108 is generally normal to the flat section 126 of the protruding section 124. In FIG. 1B the folding ledge 106 is stowed by rotating up and about the reinforcing bracket 104 such that the central platform section 108 is now adjacent to and substantially parallel with flat section 126 of the protruding section 124. More simply put, the folding ledge 106 may be deployed such that it extends perpendicularly away from the lid, i.e., the second part 116, or rotated up for storage such that it lies generally flat against the lid, i.e., the second part 116.

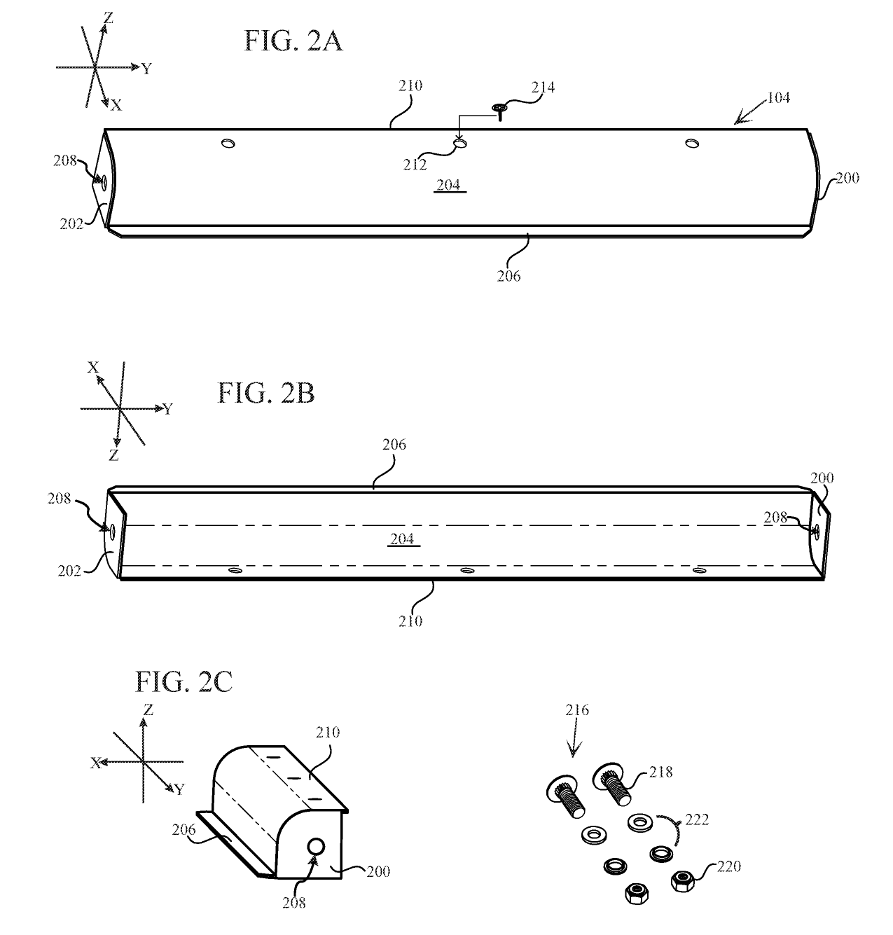

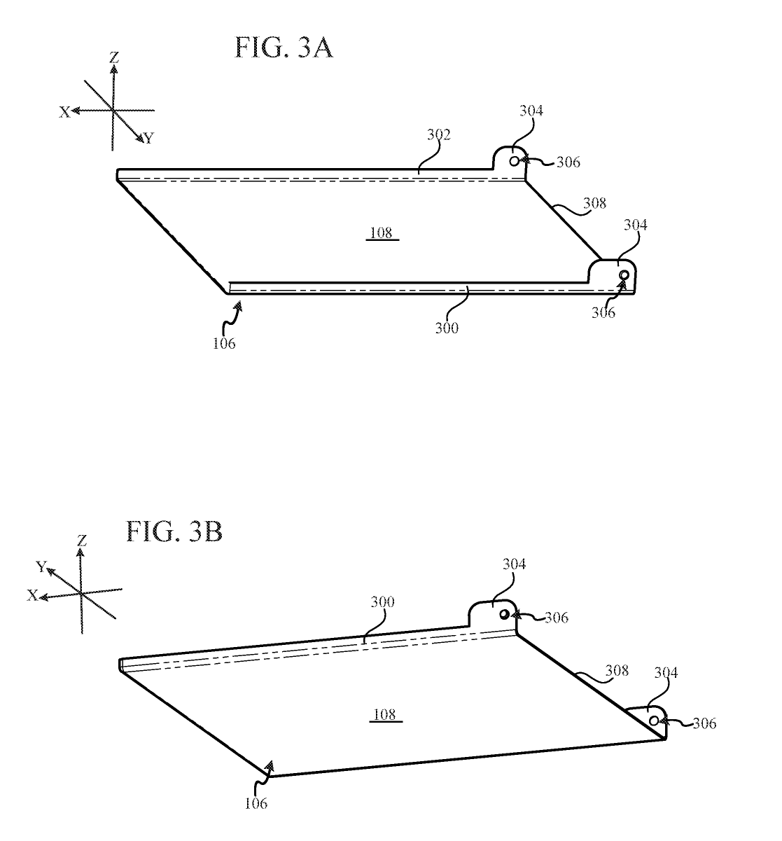

The reinforcing bracket 104 and the folding ledge 106 are more fully appreciated in FIGS. 2 and 3. More specifically, FIG. 2A is a top perspective view, FIG. 2B is a bottom perspective view and FIG. 2C is a side perspective view permitting the overall nature of the reinforcing bracket 104 to be more fully appreciated.

For at least one embodiment the reinforcing bracket 104 is a curved support bracket. In varying embodiments this reinforcing bracket 104 may be provided by composite materials and or metal. In at least one embodiment, the reinforcing bracket is formed from a pressed piece of aluminum—providing a first end 200, second end 202, a curved midsection 204 there between, and a lip 206.

The first end 200 and the second end 202 are parallel to one another and each provides a first pivot point 208. Although described as pressed, it is to be understood and appreciated that in varying embodiments the reinforcing bracket 104 may be cast, milled, forged, or otherwise provided from one or more material compounds so as to provide the first end 200, second end 202, curved midsection 204 and lip 206.

Moreover, FIGS. 2A, 2B help illustrate the general nature of the first end 200 and the second end 202 with respect to the curved midsection 204, and FIG. 2C as a side view shows the first end 200 and the conforming shape of the curved midsection 204. FIG. 2C further illustrates the relationship of the lip 206 to the curved midsection 204 and the first pivot point 208.

The top edge 210 of the curved midsection 204 will be disposed along the first end 140, and as shown is provided in at least one embodiment with one or more holes 212 permitting physical attachment with screws 214 or bolts to the protruding section 124. Further, as the first end 200 and second end 202 are parallel to each other, they will wrap around at least the lower portions of the vertical sidewalls 132, 134 of the protruding section 124 proximate to the first end 140.

For at least one embodiment, curved midsection 204 is curved so as to substantially conform and be in substantially direct contact with the material providing the bottom sidewall 138. For at least one alternative embodiment, curved midsection 204 is structured and arranged such that while the top edge 210 of curved midsection 204 of the reinforcing bracket 104 is disposed against the material providing the top flat section 126 of the protruding section 124, the lower portion of the curved midsection 204 is more gradual then the bottom sidewall 138 such that some gap may exist there between.

For the embodiment as shown, the reinforcing bracket 104 also provides a lip 206. When reinforcing bracket 104 is disposed upon the bottom sidewall 138, the lip 206 will align upon at least a portion of the coupling section 118 at the first end 140. Of course, in some embodiments, the protective case 102 may have rounded edges as has been shown, but the coupling section 118 of the second part 116 and the coupling section 120 of the first part 110 does not extend measurably beyond the outer surface of each part. Moreover the coupling section may be smooth as oppose to protruding as shown in FIGS. 1A, 1B, 4, 5A, 5B, 6A and 6B. The reinforcing bracket 104 is still applicable for such protective cases. Lip 206 may indeed extend down below the first end 140. For yet another embodiment, the lip 206 may be bent downward so as to lie against the smooth side of the protective case 102, such that it still provides a bracing surface for the folding ledge 106 when deployed to the second position.

As the protective case 102 is typically manufactured from a durable material such as polycarbonate, plastic, composite material or other such durable and environmentally resistant material, an aspect of such materials is that they are also potentially pliable under pressure. For at least one embodiment, as the folding ledge 106 pivots about the reinforcing bracket 104 the inner edge of the folding ledge 106 will bind against the lip 206 of the reinforcing bracket 104. For yet another embodiment, as the folding ledge 106 pivots about the reinforcing bracket 104 the top surface of the folding ledge 106 adjacent to the inner edge will bind against the lower portion of the curved sidewall 204 adjacent to the lip. And for yet another embodiment, as the folding ledge pivots about the reinforcing bracket 104 the top surface of the folding ledge 106 adjacent to the inner edge will bind against the lower portion of the curved sidewall 204, and the inner edge will bind against the lip 206.

As the folding ledge 106 is then buttressed by the lip 206, the lower portion of the curved midsection 204, or both elements of the reinforcing bracket 104, the cooperative interaction between the folding ledge 106 and the reinforcing bracket 104 serve to provide a stable and reliable support and means for effectively transferring the added weight of ported objected, i.e., luggage, to the protective case 102 without imposing undue stress upon the protective case 102.

For an embodiment as shown, each first pivot point 208 is generally a circular hole. The folding ledge 106 will attach to the reinforcing bracket 104 with at least one pivot attacher 210 passing through one or both pivot points 208. More specifically, for at least one embodiment the pivot attacher 216 is a bolt disposed through the circular hole provided the pivot point 208 in the first end 200 and passed out through the circular hole provided the pivot point 208 in the second end 202. For the embodiment shown, the pivot attacher 216 is provided by a set of bolts 218, with nuts 220, and optional washer(s) 222.

Turning now to FIGS. 3A and 3B, the folding ledge 106, which serves as the load platform, is further shown in FIGS. 3A (a perspective top view) and 3B (a perspective bottom view). Moreover, the folding ledge 106 has a first side section 300 and a second side section 302, each side section providing a pivot area 304 for pivot attachment to the respectively aligned first end 200 and second end 202 of the reinforcing bracket 104 shown in FIGS. 1 and 2.

Each side section provides a second pivot point 306, such as a hole, within the pivot area 304 which is structured and arranged to cooperate with the first pivot point 208 of the reinforcing bracket 104. The inner edge 308 of folding ledge 106 will brace against the lip 206 of the reinforcing bracket 104 when the folding ledge and reinforcing bracket are attached to the protective case 102, and the folding ledge 106 is rotated to it's second position where deployed to receive at a load for porting.

When pivot attachers 210, such as screws, bolts, bearings, or pins are disposed through the holes provided as the second pivot points 306 and through the holes provided as the first pivot points 208 and thereby attach the folding ledge 106 to the reinforcing bracket 104 when mounted to the first end 140 of the second part 116 of the protective case 102, the combination of the respective holes when engaged with screws, bolts, bearings, or pins provides pivoting attachment. Of course, in an alternative embodiment, the second pivot points 306 may indeed be pins that are fused to the folding ledge 108.

As with the reinforcing bracket 104, the folding ledge 106 in at least one embodiment is formed from aluminum, and more specifically from pressed aluminum. From a base sheet of material, first side section 300 and second side section 302 are bent in parallel alignment to each other. This transition from horizontal to vertical provides a significant and advantageous structural rigidity to the central section 108 and the overall folding ledge 106.

As is shown in both FIGS. 3A and 3B, the pivot area 304 rises further from the central section 108 then the rest of each first side section 300 and second side section 302. Of course in varying embodiments the height of the first side section 300 and second side section 302 may be uniform or tapered as desired for the conservation of materials, aesthetic appearance and desired structural stiffness of the folding ledge 104.

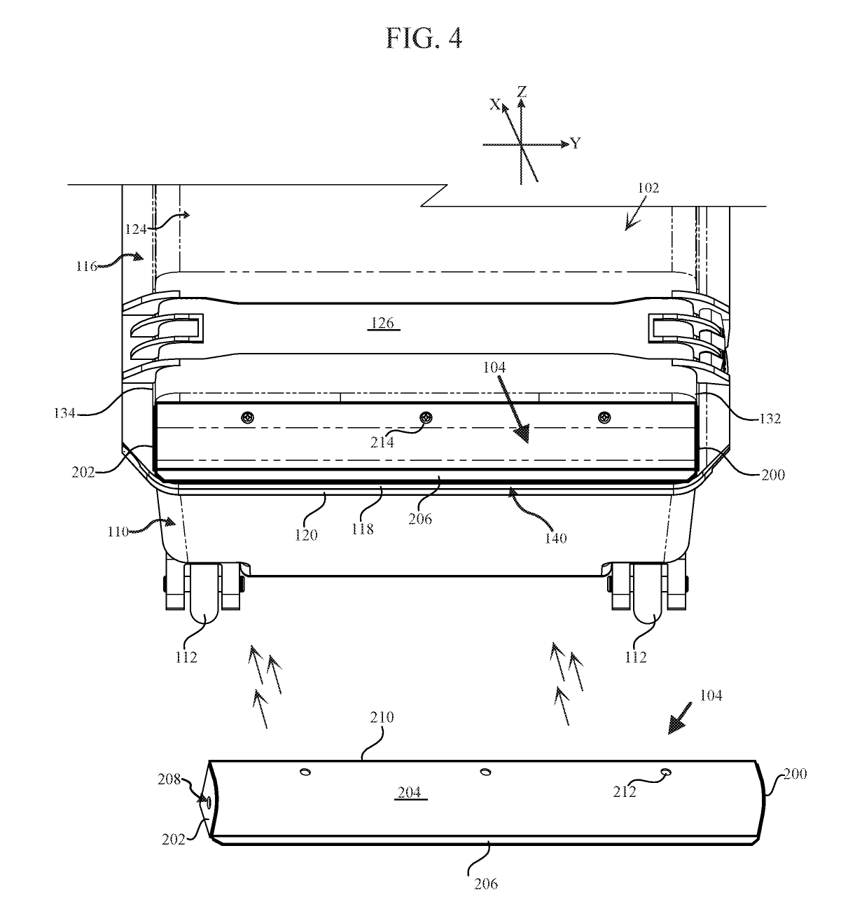

In FIG. 4, the reinforcing bracket 104 is shown installed about the first end 140 of the second part 116 of the protective case 102. For ease of identification, the installed reinforcing bracket 104 has been shown with a heavy outline. The general alignment of the first end 200 and second end 202 to the parallel sides 132, 134 of the protruding section 124, the alignment of the midsection 206 across the first end 140 and the position of the lip 206 as disposed upon a portion of the coupling section 108 are all more fully appreciated in FIG. 4.

More simply put, the reinforcing bracket 104, formed of aluminum in at least one embedment, provides a mechanical reinforcing structure to the first end 140 of the second part 116, i.e., top of the protective case. Further, the attachment of the reinforcing bracket 104 is such that the inherent structure of the second part 116 is enhanced such that when force applied as torque from the weight of one or more pieces of luggage or other items are placed on the folding ledge 106 when deployed as a load platform, this force is transferred from the folding ledge 106 to the reinforcing bracket 104 and into the overall structure of the protective case 102.

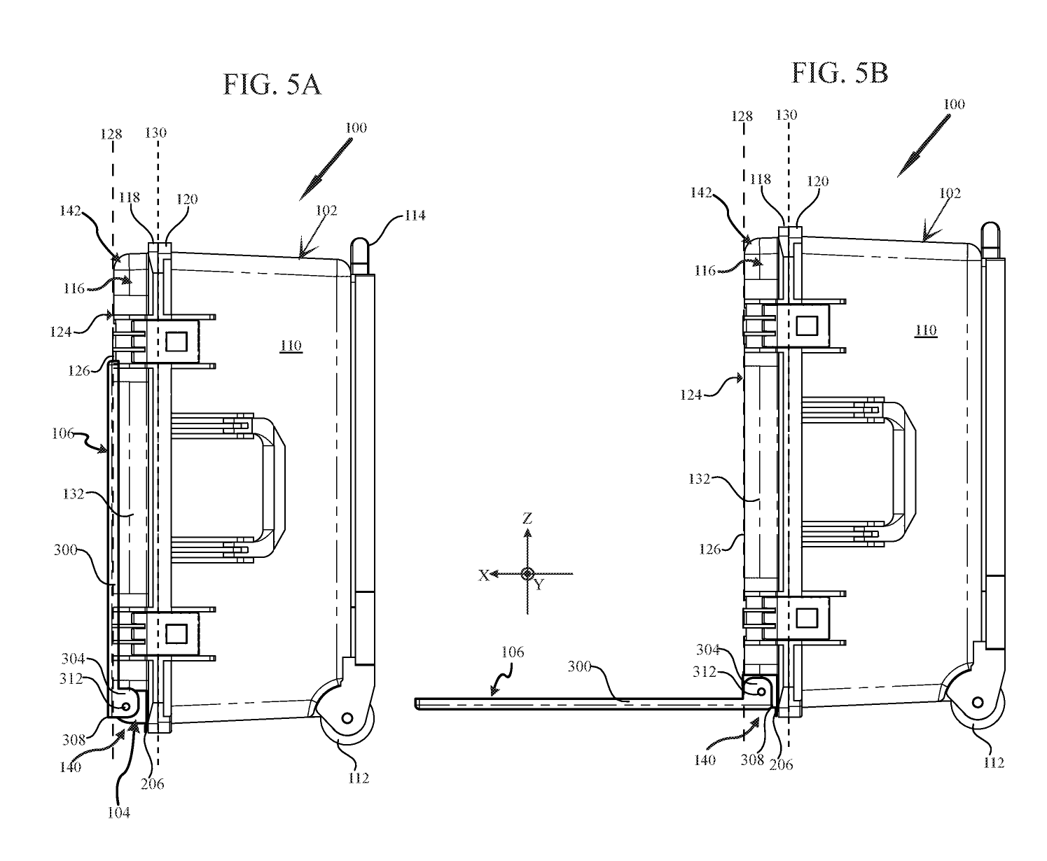

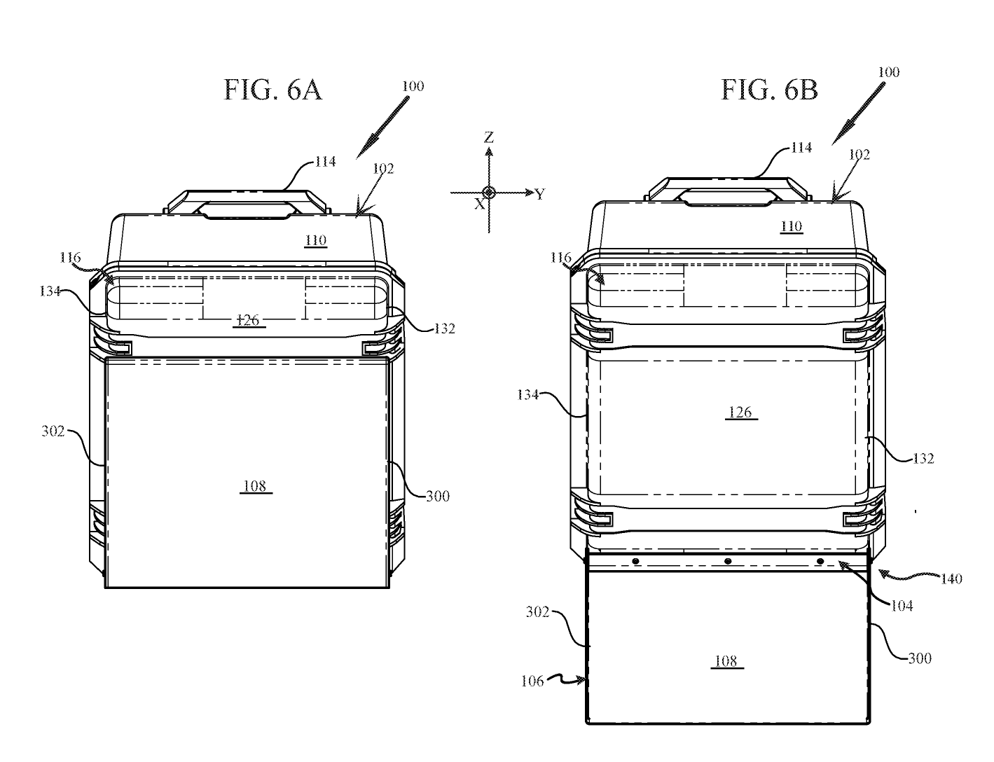

FIGS. 5A, 5B, 6A, and 6B further illustrate the deployed state (second position) and stowed state (first position) of the folding ledge 106. More specifically, FIGS. 5A and 5B are side views of the collapsible dolly 100. With respect to FIGS. 5A and 5B, the parallel relationship between the first plane 128 defined by the flat section 126 of the protruding section 124 and the second plane 130 defined by the coupling section 118 may also be appreciated.

In FIG. 5A the folding ledge 106 is shown in the first position, e.g., the stowed state, wherein it is in generally parallel contact with the protruding section 124. In FIG. 5B the folding ledge 106 is shown in the second position, e.g., deployed for use such that it is generally perpendicular to the protruding section 124. In this second position, as shown in FIG. 5B, the nature of the folding ledge 106 abutting the lip 206 is shown.

FIG. 6A is a front view of the collapsible dolly 100 corresponding to FIG. 5A, and FIG. 6B is a corresponding front view of the collapsible dolly 100 corresponding to FIG. 5B. Indeed the protective case 102 providing wheels 112 (not shown in FIG. 6A, 6B) and a handle 114 and the flat section 126 of the second part 116 provide the wheel and back elements of the collapsible dolly 100, the folding ledge 106 providing the load platform when and as desired by the traveler desiring to port additional luggage elements with the advantageous collapsible dolly 100 of the present invention.

With respect to the above description of the collapsible dolly 100, it is understood and appreciated that the reinforcing bracket 104 and folding ledge 106 may be structured and arranged for aftermarket attachment to a variety of different protective cases available on the market. For at least one embodiment, the protective case 102 is a Pelican® case. Even more specifically, for at least one embodiment the protective case is a Pelican® Storm Case® iM2500.

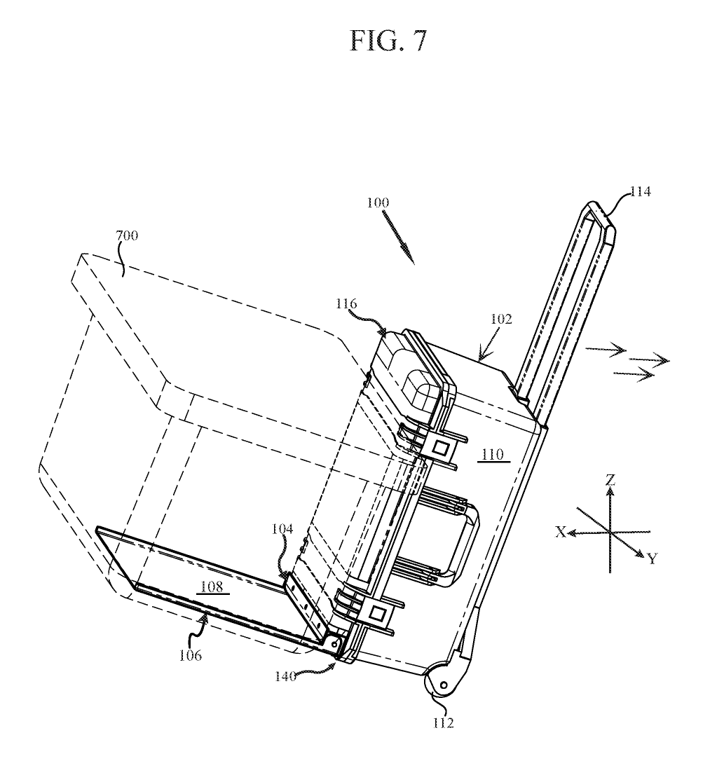

FIG. 7 shows the collapsible dolly 100 as descried above in actual use. More specifically, the folding ledge 106 has been deployed to the second position, the handle 114 of the protective case 102 has been extended, and a load 700 (shown in dotted relief) such as luggage or other items has been disposed upon the folding ledge 106. As the collapsible dolly 100 is shown pivoted about it's wheels 112, it is ready for rolling across a surface such as a floor, road, garage, walkway or other surface the user is traversing while pulling or otherwise directing the collapsible dolly 100 with the load 700.

To summarize, for at least one embodiment, provided is a system for a collapsible dolly 100 incorporating an existing protective case 102 having a lid 116 having at least one generally flat section 126 defining a first plane 128 disposed above a coupling section 118 for coupling the lid 116 to a base section 110, the coupling section 118 defining a second plane 130 generally parallel to the first plane 128, the flat section 126 and the coupling section 118 interconnected by first and second parallel side walls 132, 134, a top sidewall 136 and a bottom sidewall 138, the base section 110 further providing a wheel assembly 112 and opposite thereto a handle assembly 114, the collapsible dolly including 100: a reinforcing bracket 104 structured and arranged to be disposed about and attached to at least a portion of the bottom sidewall 138, the reinforcing bracket 104 providing first and second parallel ends 200, 202 each providing a first pivot point 208; and a folding ledge 106 having a central platform section 108 and a first side section 300 and a second side section 302, each side section providing a second pivot point 306 structured and arranged to align with and be coupled to first pivot points 208, the folding ledge 106 having a first stowed position wherein the central platform section 108 is generally parallel to the first plane 128 and adjacent to the flat section 126 of the lid 116, the folding ledge 106 having a second deployed position when rotated about the first and second pivot points 208, 306 wherein the central platform section 108 is generally perpendicular to the flat section 126 of the lid 116.

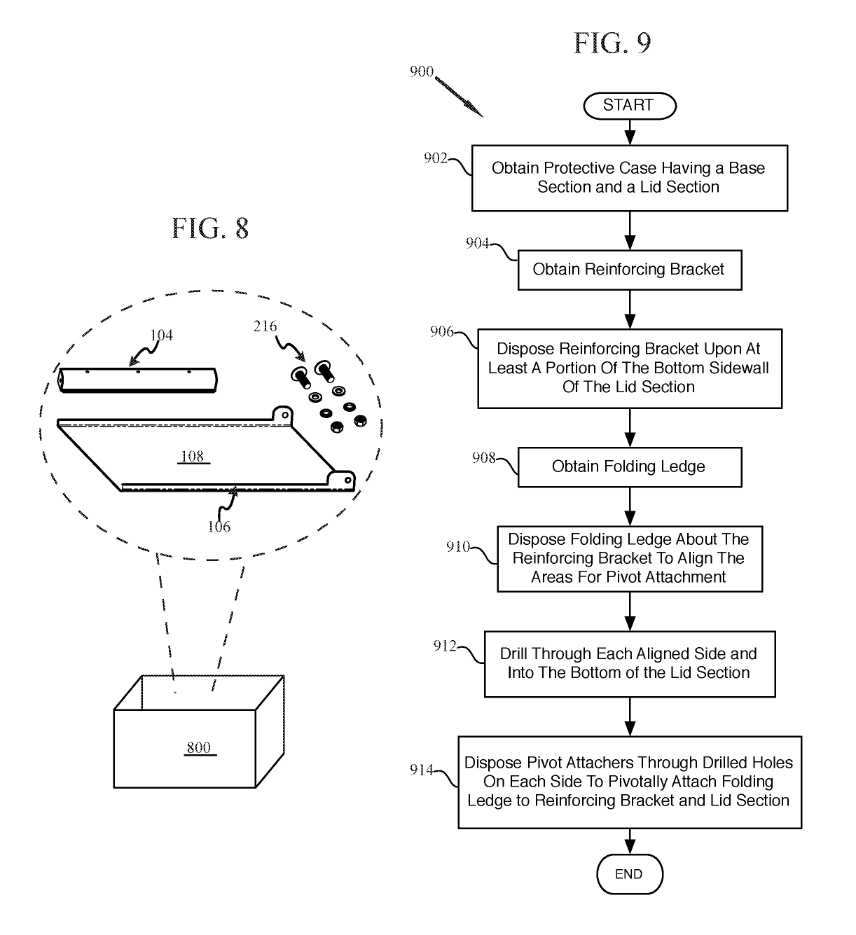

With respect to the above description and accompanying figures, it should be understood and appreciated that the collapsible dolly 100 may be provided as a distinct unit for sale and use. Indeed for at least one embodiment, the collapsible dolly 100 incorporating a protective case 102 is provided as a kit 800 as shown in FIG. 8. For example, in at least one embodiment such a kit includes a reinforcing bracket 104, a folding ledge 106, and at least one pivot attacher 216 for hinging the folding ledge to the reinforcing bracket. The kit 800 may also include at least one attacher for attaching the reinforcing bracket to the bottom sidewall of the lid of the protective case, however when bolts and nuts are used as the pivot attachers 216, the assemblage of components inherently attaches the reinforcing bracket 104 to the first end 140. In varying embodiments, the kit may further include drill bits, rubber grommets, washers, wrenches or other materials suitable for installation of the folding ledge and reinforcing bracket upon a protective case.

The installation of the reinforcing bracket and folding ledge upon a protective case may be more fully appreciated with reference to FIG. 9 presenting a flow diagram for method 900 of providing a collapsible dolly 100 incorporating a protective case 102. Of course it will be appreciated that the steps herein described need not be performed in the order herein presented, but that this method 900 is merely exemplary of one method which may be employed.

For at least one embodiment, method 900 commences with the installer, i.e., person performing the installation, obtaining a protective case 102 having a base section 110 and a lid section 116, block 902. Moreover, for at least one embodiment the protective case 102 is substantially as described above.

Method 900 continues with the person obtaining a reinforcing bracket 104, block 904. As with the protective case 102, the reinforcing bracket 104 is substantially as described above. Setting the protective case 102 on a firm work surface with the bottom of the case towards the installer, the reinforcing bracket 104 is disposed upon at least a portion of the bottom sidewall 138 of the lid section 116, block 906.

Optionally, the installer may drill through the upper edge of the curved midsection 204 of the reinforcing bracket 104 and install one or more attachers, such as screws, to affix the reinforcing bracket 104 to the lid section 116.

Method 900 continues with the installer then obtaining a folding ledge 106, block 908. Again, for at least one embodiment the folding ledge 106 is substantially as described above. The installer then proceeds to dispose the folding ledge 106 about the reinforcing bracket 104 to align the pivot areas 304 of the first and second side sections 300, 302 of the folding ledge 106 to the respectively aligned first and second parallel ends 200, 202 of the reinforcing bracket 104, block 910.

With the folding ledge 106 and reinforcing bracket 104 so aligned, the installer proceeds to drill through each aligned side and into the bottom of the lid section 116, block 912. Next, the installer disposes pivot attachers 216 through each hole, block 914. More specifically, the folding ledge 106 is disposed over the reinforcing bracket 104 and aligned to the hinge holes drilled on each side. Two pivot attachers 216, such as two large bolts provided with the kit 800 provisions may be used, and inserted into the holes through rubber grommets.

From inside the case, the installer can install a fender washer and nut upon the inner portion of each bolt, and snugging tighten each nut. For at least one embodiment the nuts are locking castle nuts such that they will remain bound to the threads of the bolt at whatever location the installer selects. As such, the nuts may be tightened to hold the bolts securely, but still permit easy rotation of the folding ledge 106. The installation is now complete and the protective case 102 has now been incorporated as part of a new and advantageous collapsible dolly 100.

Changes may be made in the above methods, systems and structures without departing from the scope hereof. It should thus be noted that the matter contained in the above description and/or shown in the accompanying drawings should be interpreted as illustrative and not in a limiting sense. Indeed many other embodiments are feasible and possible, as will be evident to one of ordinary skill in the art. The claims that follow are not limited by or to the embodiments discussed herein, but are limited solely by their terms and the Doctrine of Equivalents.

What is claimed is:

1. A collapsible dolly incorporating a protective case, comprising:
a protective case having at least two halves defining a protected space therein, a first part providing wheels at a lower end and a handle at an upper end, and a second part providing a top, the second part further providing a coupling section for binding to the first part and a protruding section extending above and generally parallel to the coupling section, the protective case having a general wheel end and opposite thereto a general grasping end, the protruding section of the second part having a first end proximate to the wheel end and a second end proximate to the grasping end;
a reinforcing bracket disposed about the first end of the protruding section;
a folding ledge structured and arranged to rotatably couple to the second part adjacent to the first end of the protruding section and proximate to the wheel end, and rotate between a first position and a second position, the folding ledge in generally parallel contact with the protruding section when in the first position and extending generally perpendicularly to the protruding section and binding against the reinforcing section when in the second position.

2. The collapsible dolly of claim 1, wherein the reinforcing bracket is a curved aluminum support bracket.

3. The collapsible dolly of claim 1, wherein the reinforcing bracket has a first end, a second end parallel to the first end, a curved midsection there between, and a lip along at least a portion of the mid section.

4. The collapsible dolly of claim 2, wherein a pivot point is provided in the first end and the second end.

5. The collapsible dolly of claim 1, wherein the folding ledge is aluminum.

6. The collapsible dolly of claim 1, further including at least one pivot attacher structured and arranged to rotatibaly coupling the folding ledge to the reinforcing bracket.

7. The collapsible dolly of claim 1, wherein the case further provides a towing handle, the folding ledge in the second position permitting a user to tow the protective case and its contents and at least one other object as disposed against the folding ledge.

8. The collapsible dolly of claim 1, wherein the protective case is a Pelican™ case.

9. A collapsible dolly incorporating an existing protective case having a lid with at least one generally flat section defining a first plane disposed above a coupling section for coupling the lid to a base section, the coupling section defining a second plane generally parallel to the first plane, the flat section and the coupling section interconnected by first and second parallel side walls, a top side wall and a bottom sidewall, the base section further providing a wheel assembly and opposite thereto a handle assembly, the collapsible dolly comprising:
a reinforcing bracket structured and arranged to be disposed about and attached to at least a portion of the bottom sidewall, the reinforcing bracket providing first and second parallel ends with each providing a first pivot point; and
a folding ledge having a central platform section and a first side section and a second side section, each side section providing a second pivot point structured and arranged to align with and be coupled to first pivot points, the folding ledge having a first stowed position wherein the central platform section is generally parallel to the first plane and adjacent to the flat section of the lid, the folding ledge having a second deployed position when rotated about the first and second pivot points wherein the central platform section is generally perpendicular to the flat section of the lid.

10. The collapsible dolly of claim 9, wherein the reinforcing bracket is a curved aluminum support bracket.

11. The collapsible dolly of claim 9, wherein the reinforcing bracket has a first end, a second end parallel to the first end, a curved midsection there between, and a lip along at least a portion of the mid section.

12. The collapsible dolly of claim 9, wherein the folding ledge is aluminum.

13. The collapsible dolly of claim 9, further including at least one pivot attacher for hinging the folding ledge to the reinforcing bracket.

14. The collapsible dolly of claim 13, wherein the at least one pivot attacher for hinging the folding ledge to the reinforcing bracket is a set of bolts disposed through the second pivot points of the folding ledge through the respectively aligned first pivot points of first and second parallel ends.

15. The collapsible dolly of claim 13, wherein the at least one pivot attacher for hinging the folding ledge to the reinforcing bracket is a rod disposed through the second pivot points of the folding ledge through the respectively aligned first pivot points of first and second parallel ends.

16. The collapsible dolly of claim 9, further including at least one attacher for attaching the reinforcing bracket to the bottom sidewall of the lid.

17. The collapsible dolly of claim 9, wherein the protective case is a Pelican™ case.

18. The collapsible dolly of claim 9, wherein the case further provides a towing handle, the folding ledge in the second position permitting a user to tow the protective case and it's contents and at least one other object as disposed against the folding ledge.

19. A kit for providing a collapsible dolly incorporating an existing protective case having a lid with at least one generally flat section defining a first plane disposed above a coupling section for coupling the lid to a base section, the coupling section defining a second plane generally parallel to the first plane, the flat section and the coupling section interconnected by first and second parallel side walls, a top side wall and a bottom sidewall, the base section further providing a wheel assembly and opposite thereto a handle assembly, comprising:
a reinforcing bracket structured and arranged to be disposed about and attached to at least a portion of the bottom sidewall, the reinforcing bracket providing first and second parallel ends;
a folding ledge having a central platform section and a first side section and a second side section, each side section providing an area for pivot attachment to the respectively aligned first and second parallel ends;
at least one pivot attacher for hinging the folding ledge to the reinforcing bracket;
wherein when the reinforcing bracket and folding ledge are attached to an existing case, the folding ledge has a first stowed position wherein the central platform section is generally parallel to the first plane and adjacent to the flat section of the lid, the folding ledge having a second deployed position when rotated about the at least one pivot attacher wherein the central platform section is generally perpendicular to the flat section of the lid.

20. The kit of claim 19, wherein the at least one pivot attacher for hinging the folding ledge to the reinforcing bracket is a bolt disposed through each side section of the folding ledge into the to the respectively aligned first and second parallel ends.

21. The kit of claim 19, wherein the at least one pivot attacher for hinging the folding ledge to the reinforcing bracket is a rod disposed through the side section of the folding ledge through the to the respectively aligned first and second parallel ends.

22. The kit of claim 19, wherein the reinforcing bracket is a curved aluminum support bracket.

23. The kit of claim 19, wherein the reinforcing bracket has a first end, a second end parallel to the first end, a curved midsection there between, and a lip along at least a portion of the mid section.

24. The kit of claim 19, wherein the folding ledge is aluminum.

25. The kit of claim 19, wherein the case further provides a towing handle, the folding ledge in the second position permitting a user to tow the protective case and it's contents and at least one other object as disposed against the folding ledge.

26. The kit of claim 19, wherein the kit is adapted for use with a Pelican™ case.

27. A method for providing a collapsible dolly, comprising:
obtaining a protective case having a lid having at least one generally flat section defining a first plane disposed above a coupling section for coupling the lid to a base section, the coupling section defining a second plane generally parallel to the first plane, the flat section and the coupling section interconnected by first and second parallel side walls, a top side wall and a bottom sidewall, the base section further providing a wheel assembly and opposite thereto a handle assembly;
obtaining a reinforcing bracket structured and arranged to be disposed about and attached to at least a portion of the bottom sidewall, the reinforcing bracket providing first and second parallel ends;
disposing the reinforcing bracket upon at least a portion of the bottom sidewall of the lid, the first and second parallel ends being adjacent to respective first and second parallel sidewalls of the lid;
obtaining a folding ledge having a central platform section and a first side section and a second side section, each side section providing an area for pivot attachment to the respectively aligned first and second parallel ends of the reinforcing bracket;
disposing the folding ledge about the reinforcing bracket to align the areas for pivot attachment of the first and second side sections to the respectively aligned first and second parallel ends of the reinforcing bracket;
drilling a hole through each area for pivot attachment of the first and second side sections and the respectively aligned first and second parallel ends of the reinforcing bracket; and
disposing a pivot attacher in each drilled hole to hinge the folding ledge to the reinforcing bracket;
wherein with the reinforcing bracket and folding ledge attached to the protective case, the folding ledge has a first stowed position wherein the central platform section is generally parallel to the first plane and adjacent to the flat section of the lid, the folding ledge having a second deployed position when rotated about the at least one pivot attacher wherein the central platform section is generally perpendicular to the flat section of the lid.

28. The method of claim 27, wherein the at least one pivot attacher for hinging the folding ledge to the reinforcing bracket is a bolt disposed through the hole in each side section of the folding ledge into the respectively aligned hole in each of the first and second parallel ends.

29. The method of claim 27, wherein the at least one pivot attacher for hinging the folding ledge to the reinforcing bracket is a rod disposed through the hole in each side section of the folding ledge into the respectively aligned hole in each of the first and second parallel ends.

30. The method of claim 27, wherein the reinforcing bracket is a curved aluminum support bracket.

31. The method of claim 27, wherein the folding ledge is formed aluminum, the first and second side sections provided by respective side sections bent generally perpendicularly to the central platform section.

32. The method of claim 27, wherein the case further provides a towing handle, the folding ledge in the second position permitting a user to tow the protective case and it's contents and at least one other object as disposed against the folding ledge.

33. The method of claim 27, wherein the protective case is a Pelican™ case.
